(19) United States
(12) Patent Application Publication
(10) Pub. No.: US 2016/0008734 A1
(43) Pub. Date: Jan. 14, 2016

(54) DEVICE AND METHOD FOR VACUUM DEHYDRATION OF LOW-VOLATILE LIQUID

(71) Applicant: Wenbing WANG, Beijing (CN)

(72) Inventor: Wenbing WANG, Beijing (CN)

(21) Appl. No.: 14/864,805

(22) Filed: Sep. 24, 2015

Related U.S. Application Data
(63) Continuation-in-part of application No. PCT/CN2014/074330, filed on Mar. 28, 2014.

(30) Foreign Application Priority Data
Mar. 29, 2013 (CN) 201310106167.1

(51) Int. Cl. B01D 3/10

(52) U.S. Cl. CPC B01D 3/106

(57) ABSTRACT

A device for vacuum dehydration of a low-volatile liquid, the device including: a vacuum tank, a condenser, a water discharging device, and a pump for extraction of the gas-liquid mixture. The vacuum tank includes: a liquid inlet, an outlet, a mixed space of a gas-liquid mixture, and a gas-phase space. The condenser is disposed in the gas-phase space of the vacuum tank. The outlet of the vacuum tank is connected to the pump. The gas-phase space is formed above the mixed space and communicates with the mixed space. The gas-liquid mixture is discharged out of the vacuum tank via the outlet thereof by the pump. Water vapor in the gas-phase space is condensed and discharged out of the vacuum tank via the water discharging device.

### CROSS-REFERENCE TO RELATED APPLICATIONS

This application is a continuation-in-part of International Patent Application No. PCT/CN2014/074330 with an international filing date of Mar. 28, 2014, designating the United States, now pending, and further claims priority benefits to Chinese Patent Application No. 201310106167.1 filed Mar. 29, 2013. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a method and a device for vacuum dehydration of a low-volatile liquid.

2. Description of the Related Art

Typically, as shown in FIG. 1, vacuum dehydration of a low-volatile liquid is performed by introducing a water-containing liquid into a vacuum tank 1 via a liquid inlet 2 and evaporating the liquid to form a gas-liquid mixture. Specifically, the liquid is accumulated at the bottom of the vacuum tank and is extracted from the outlet 3 of the vacuum tank by a liquid pump 8. The gas accumulating at the upper part of the vacuum tank is pumped out via a gas outlet 4 by a vacuum pump 6. In addition, a condenser 5 and a water discharging device 7 are disposed between the vacuum tank 1 and the vacuum pump 6 to condense the water vapor and discharge the water.

However, when the method is applied to oil having large moisture content, a large amount of oil-containing foam is produced and accumulates at the top of the vacuum tank due to the rapid evaporation of the water. With the extraction of the vapor by the vacuum pump 6, the oil-containing foam is also pumped out. This causes oil loss and has a detrimental effect on the vacuum pump. To detect the generation of the foam, a detection probe must be disposed in the vacuum chamber. As a result, a conventional dehydration system is complex, large, heavy and cumbersome, and the dehydration efficiency thereof is low.

### SUMMARY OF THE INVENTION

In view of the above-described problems, it is one objective of the invention to provide a device and a method for vacuum dehydration of a low-volatile liquid. The device and the method are adaptable to vacuum dehydration of the low-volatile liquid, particularly to vacuum dehydration of lubricant oils, such as turbine oil, gear oil, and hydraulic oil.

To achieve the above objective, in accordance with one embodiment of the invention, there is provided a vacuum dehydration device for a low-volatile liquid. The device comprises: a vacuum tank, the vacuum tank comprising: a liquid inlet, an outlet, a mixed space of a gas-liquid mixture, and a gas-phase space; a condenser disposed in the gas-phase space; a water discharging device; and a pump for extraction of the gas-liquid mixture. The outlet of the vacuum tank is connected to the pump. The mixed space of the gas-liquid mixture and the gas-phase space are disposed inside the vacuum tank. The mixed space of the gas-liquid mixture is formed by a liquid after entering the vacuum tank. The gas-phase space is formed above the mixed space and communicates with the mixed space. The gas-liquid mixture is discharged out of the vacuum tank via the outlet thereof by the pump for extraction of the gas-liquid mixture. Part of gas enters the gas-phase space. Water vapor in the gas-phase space is condensed into a liquid state or a solid state by the condenser, and water in the liquid state or the solid state is discontinuously or continuously discharged out of the vacuum tank via the water discharging device.

In a class of this embodiment, a liquid pump is connected to a bottom of the vacuum tank.

In a class of this embodiment, the gas-phase space comprises a gas circulation loop. The gas circulation loop communicates with the vacuum tank for gas circulation. The condenser is disposed in the gas circulation loop.

In a class of this embodiment, a blower is disposed in the gas-phase space for increasing a gas exchange rate in the vacuum tank.

In a class of this embodiment, the condenser adopts cold water cooling, compressor refrigeration, semiconductor refrigeration, or a combination thereof; and a heat quantity produced from refrigeration of the condenser is carried away by the low-volatile liquid.

In accordance with another embodiment of the invention, there is provided a method for vacuum dehydration of a low-volatile liquid. The method comprises:

a) injecting a low-volatile liquid into a vacuum tank, and evaporating water vapor and gas from the liquid to form a gas-liquid mixture; partially separating the gas-liquid mixture under the action of the gravity, whereby producing a mixed space of a gas-liquid mixture and a gas-phase space communicating with the mixed space in a chamber of the vacuum tank;

b) condensing the water vapor in the gas-phase space into:
a liquid state, where the water in the liquid state is discontinuously or continuously discharged out of the vacuum tank; and/or
a solid state, where the water in the solid state is discontinuously discharged out of the vacuum tank after being melted; and

c) extracting the gas-liquid mixture from the mixed space out of the vacuum tank whereby maintaining the vacuum tank at a negative pressure state.

In a class of this embodiment, a gas circulation loop is added in b) to facilitate a flow of the water vapor to the condenser.

In a class of this embodiment, the gas circulation loop adopts a vacuum pipe communicating with the gas-phase space of the vacuum tank, and the gas flow is appropriately guided to facilitate the flow of the water vapor to the condenser whereby increasing the dehydration rate.

In a class of this embodiment, a blower is adopted in b) for enhancing the gas flow in the gas-phase space whereby increasing the dehydration rate.

In a class of this embodiment, a heat quantity produced in refrigeration of the condenser in b) is carried away by the low-volatile liquid.

In a class of this embodiment, a part of the liquid is extracted from the mixed space by a pump so as to increase a treated flow of the low-volatile liquid.

Advantages according to embodiments of the invention are summarized as follows:

The leakage problem of the oil-containing foam from the vacuum oil purifier and the difficulty of the discharge of high viscosity liquid from the vacuum tank are overcome. Because the pump for extraction of the gas-liquid mixture is adopted, the liquid pump and the vacuum pump are integrated, and both the volume and the weight of the vacuum dehydration device are largely reduced. In addition, the method of the invention has low requirement for automatic control, high reliability, and simple operation.

### BRIEF DESCRIPTION OF THE DRAWINGS

The invention is described hereinbelow with reference to the accompanying drawings, in which:

FIG. 1 is a structure diagram of a typical vacuum dehydration device in the prior art. Gas is pumped out of a vacuum tank via a gas outlet disposed on the top thereof, and a liquid is pumped out of the vacuum tank via an outlet disposed on the bottom thereof. When the content of the water vapor is not high, a condenser 5 and a water discharging device are deleted, that is, a vacuum pump 6 is adapted to pump the gas including the water vapor out of the vacuum tank.

FIG. 2 is a structure diagram of a vacuum degassing device having a relatively small flow rate. A liquid is injected into a vacuum tank 1 via a liquid inlet 2. A gas-liquid mixture is formed by evaporating a gas from the liquid and partially separated under the action of the gravity, so that a mixed space 21 of the gas-liquid mixture is formed at a middle-lower part of the vacuum tank 1, and the gas-liquid mixture is pumped out of the vacuum tank via an outlet 3 disposed at a bottom thereof via a pump 22 for extraction of the gas-liquid mixture. The gas flows towards an upper part of the vacuum tank and is accumulated to form a gas-phase space 20. Water vapor in the gas is condensed into water or ice by a condenser 5 and is finally discharged out of the vacuum tank by a water discharging device 7. The device is adapted to dehydrate a low-volatile liquid including lubricant oil, but has a relatively poor removing effect on a gas not easily condensed.

FIG. 3 is a structure diagram of a vacuum oil purifier having a relatively large flow rate. As a liquid pump 8 (oil discharging pump) is added, a liquid flow rate of a pump 22 for extraction of the gas-liquid mixture can be reduced, thus, the device has much stronger adaptability and is suitable for occasions having relatively large flow rate.

FIG. 4 is a structure diagram of a vacuum oil purifier in which a condenser 5 is disposed outside a vacuum tank 1. A gas-phase space 20 is extended outside a vacuum tank 1 via a vacuum pipe system, and generally a blower 23 is provided to facilitate gas circulation.

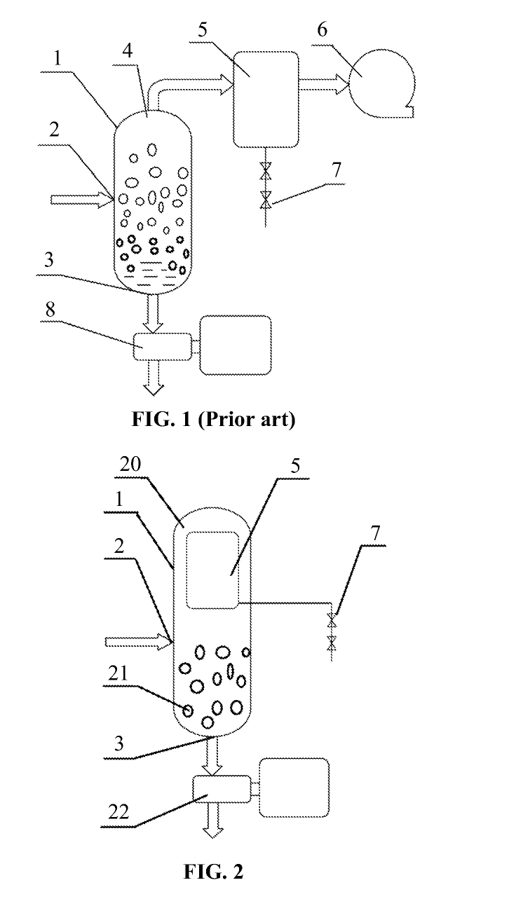

In the drawings, the following reference numbers are used: 1. Vacuum tank; 2. Liquid inlet of vacuum tank; 3. Outlet of vacuum tank; 4. Gas outlet disposed at top of vacuum tank; 5. Condenser; 6. Vacuum pump; 7. Water discharging device; 8. Liquid pump; 20. Gas-phase space in vacuum pump; 21. Mixed space of gas-liquid mixture; 22. Pump for extraction of gas-liquid mixture; and 23. Blower.

### DETAILED DESCRIPTION OF THE EMBODIMENTS

For further illustrating the invention, experiments detailing a device and a method for vacuum dehydration of a low-volatile liquid are described below. It should be noted that the following examples are intended to describe and not to limit the invention.

Low-volatile liquid in this invention refers to a kind of liquid, under normal vacuum dehydration condition, most of water in the liquid is evaporated to yield vapor, while the effective component of the liquid is hardly evaporated or the evaporation thereof is negligible.

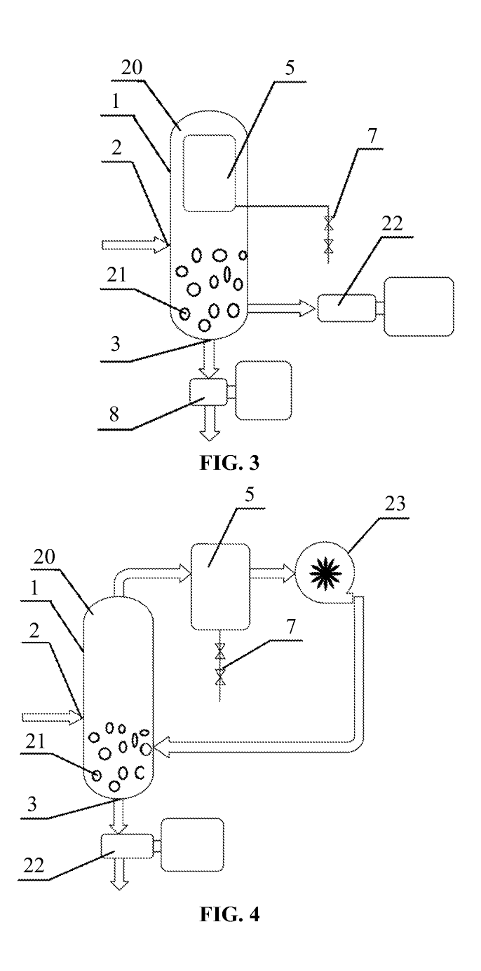

As shown in FIG. 2, the low-volatile liquid is injected into a vacuum tank 1 via a liquid inlet 2. A gas-liquid mixture is formed by evaporating water vapor and gas from the liquid and partially separated under the action of the gravity, so that a mixed space 21 of the gas-liquid mixture and a gas-phase space 20 disposed above the mixed space are formed in the vacuum tank. A pump 22 for extraction of the gas-liquid mixture is adopted and is able to extract the gas and the liquid from the mixed space 21, i. e., a bottom part or a middle-lower part of the vacuum tank, out of the vacuum tank 1. The gas-phase space is provided with a condenser 5 so as to condense water vapor into water or ice (the ice needs to be melted into water discontinuously) and discharge the water out of the vacuum tank 1 via a water discharging device 7. A liquid discharged by the pump 22 for extraction of the gas-liquid mixture is treated with gas-liquid separation and filtration according to a practical condition. When the liquid to be treated has a large flow quantity, optionally an outlet of gas-liquid mixture is disposed at a middle part of the mixed space 21, and a liquid pump 8 is disposed at the bottom of the vacuum tank for extracting the liquid out, as shown in FIG. 3.

Principle of the device and the method for vacuum dehydrating the low-volatile liquid of the invention is as follows: because a position in the vicinity of an inlet of the pump 22 for extraction of the gas-liquid mixture is the position having the lowest pressure in the vacuum tank 1, the liquid and the gas from the liquid inlet preferably move towards the outlet 3 of the vacuum tank, the gas-liquid mixture and those liquids having high viscosities are easily discharged. As an upper part of the vacuum tank is not the position having the lowest pressure, no upward driving force is imposed on the gas-liquid mixture in the foam state, thus a space in the absence of the foam, that is, the gas-phase space, is formed in a position at a certain height within the vacuum tank. The gas in the vacuum tank has a light specific weight, therefore the gas is able to uplift to the vicinity of the condenser 5 naturally or in the presence of a fan, then the water vapor in the gas is condensed into water or ice. The ice is generally melted into water through a discontinuous defrosting process and is discharged out of the vacuum tank 1 via the water discharging device 7.

The device of the invention relates to two new parts. One is the condenser 5 (generally comprising a water discharging device 7) installed in the gas-phase space of the vacuum tank, and the other is the pump 22 for extraction of the gas-liquid mixture.

The condenser should possess the following properties: 1. The condenser must have a temperature relatively low than the temperature of oil, the larger the temperature difference is, the better the dehydration effect is. However, the discontinuous defrosting treatment is required to discharge the water when the ice is formed. 2. The condensed water must be collected; 3. The water discharging device of the condenser is able to discharge the water out of the vacuum tank; 4. It's better for the condenser to be equipped with a blower so as to facilitate gases including the water vapor to flow to a cooling surface of the condenser and to increase the dehydration rate; 5. A condensing part is adaptable to work at the vacuum environment in the vacuum tank. In order to satisfy the above conditions, the condenser adopts cold water cooling, compressor refrigeration, semiconductor refrigeration, or a combination thereof. The compressor refrigeration or the semiconductor refrigeration is recommended due that large temperature differences can be acquired compared with the direct cooling by the cold water. And in some circumstances, a heat quantity of the condenser is carried away by the liquid to be dehydrated.

The water discharging device 7 is closely related to the condenser 5, and can be viewed as a part of the condenser. The water discharging optionally adopts a miniature water pump or switch of a group of valves at different time points to discharge the water, as long as the type is reasonable and the structure is proper, these techniques are able to meet the use requirement. The condenser 5 is installed in the gas phase space 20, and is specifically disposed in or outside the vacuum tank, as shown in FIG. 4. The pipe system is connected to the vacuum tank 1, that is, the gas-phase space 20 is expanded by the pipe system, and generally the blower 23 is provided to facilitate the gas circulation.

As shown in FIG. 4, a position on the vacuum tank 1 where a non-condensed gas of an externally arranged condenser 5 is returned is variable, and the effect is slightly different for different positions, thus, the position where the non-condensed gas is returned is adjusted according to the practical application. Except the expansion of the gas-phase space by the pipeline system, the vacuum tank is also provided with partition plates so as to form a much effective gas circulation loop, thereby realizing the similar effect.

The pump 22 for extraction of the gas-liquid mixture in the invention is obtained by improving structures and parameters based on an oil vacuum pump. Theoretically, most vacuum pumps using oil or even not using oil, including a sliding vane rotary vacuum pump, a screw vacuum pump, a Roots vacuum pump, a pawl-type vacuum pump, and a liquid ring vacuum pump, are able to extract a small amount of liquid and adaptable to the device of the invention, but the specific type, parameters, and the structure thereof must be optimized according to specific application conditions so as to satisfy the requirements of synchronous processes of vacuum pumping and liquid pumping and the long term stable operation. When the liquid to be dehydrated has a low viscosity, the liquid ring vacuum pump is able to basically satisfy the use requirement. In addition, some volumetric oil pump, such as a gear pump, a rotor pump, a vane pump, and a screw pump, also satisfies the requirement of pumping a certain volume of gas after some certain improvements and parameter optimization.

In practical application of the method, some working parameters, such as the pressure, the temperature, the flow rate of the inlet liquid, and the gas circulation flow rate of the vacuum tank are always needs to be monitored and controlled by adopting an automatic control device, thereby realizing a relatively ideal dehydration effect.

The device for vacuum dehydrating the low-volatile liquid of the invention further requires some other components to form an integral dehydration system, such as a monitoring instrument, a pipe valve, a filter, a heater, an automatic control and regulation system, and a frame and a housing of a device. These components are known by those skilled in the art, and the kinds, types, and structures thereof are various and can form multiple combinations.

A vacuum oil filter adopting the technical scheme of the invention is exemplified as follows:

A vacuum oil filter working on-line is adapted to treat 500 L of #46 lubricant oil. A temperature of the operating oil is approximately at 50° C., and a demanded flow rate of the oil in the treatment is 5 L/min. As the temperature is appropriate, no additional heater is required, and the process is as follows: the oil from an oil tank to be treated is introduced to a crude filter via a first pipe provided with a first valve and is then introduced to a vacuum tank. A gas-liquid mixture is pumped out from a bottom part of the vacuum tank by a pump 22 for extraction of the gas-liquid mixture and is introduced to a filter comprising a space with a certain volume disposed at an upper part thereof. A gas in the filter is dissolved in the oil, and the oil after filtration is returned to the oil tank to be treated via a second pipe and a second valve.

As the flow rate of the oil to be treated is relatively small, the upper part of the vacuum tank is provided with a condenser. The condenser adopts a semiconductor for refrigeration and a controller for automatically controlling the temperature so as to maintain a temperature of a condensing surface at between 0 and 10° C. The water discharging device adopts double-valve switch operation.

An improved liquid ring vacuum pump is utilized as a pump 22 for extraction of the gas-liquid mixture. The liquid ring vacuum pump has a motor power of 1.5 kW and a weight of approximately 25 kg.

Other components, comprising the crude filter, the vacuum tank, the fine filter, the pipe system, the control box, and the frame, have a total weight of 60 kg, which is much lighter than the vacuum oil filter having the lightest weight on the market. During the test period, an actual dehydration rate is greatly related to the water content of the fed oil, and can reach 20 g/h.

A method for vacuum dehydrating the low-volatile liquid, comprises the following steps:

a) injecting the low-volatile liquid into a vacuum tank 1, and evaporating water vapor and gas from the liquid to form a gas-liquid mixture; partially separating the gas-liquid mixture under the action of the gravity, whereby producing a mixed space 21 of a gas-liquid mixture and a gas-phase space 20 communicating with the mixed space 21 in a chamber of the vacuum tank 1;

b) condensing the water vapor in the gas-phase space 20 into:
a liquid state which is discontinuously or continuously discharged out of the vacuum tank; and/or
a solid state which is discontinuously discharged out of the vacuum tank after being melted; and

c) extracting the gas-liquid mixture from the mixed space out of the vacuum tank whereby maintaining the vacuum tank at a negative pressure state. Sometimes an automatic control device is required to keep a proper vacuum degree.

A gas circulation loop is added in b) to facilitate a flow of the water vapor to the condenser.

The gas circulation loop adopts a vacuum pipe communicating with the gas-phase space of the vacuum tank, and the gas flow is appropriately guided to facilitate the flow of the water vapor to the condenser whereby increasing the dehydration rate.

A blower is adopted in b) for enhancing the gas flow in the gas-phase space whereby increasing the dehydration rate.

The heat quantity produced in refrigeration of the condenser in b) is carried away by the low-volatile liquid.

A part of the liquid is extracted from the mixed space by a pump so as to increase a treated flow of the low-volatile liquid.

Apparently, the instrument and the automatic control system are adapted to control operating parameters for the purpose of improving the dehydration rate.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A device for vacuum dehydration of a low-volatile liquid, the device comprising:
a) a vacuum tank, the vacuum tank comprising: a liquid inlet, an outlet, a mixed space of a gas-liquid mixture, and a gas-phase space;
b) a condenser, the condenser being disposed in the gas-phase space;
c) a water discharging device; and
d) a pump for extraction of the gas-liquid mixture;
wherein
the outlet of the vacuum tank is connected to the pump for extraction of the gas-liquid mixture;
the mixed space of the gas-liquid mixture and the gas-phase space are disposed inside the vacuum tank;
the mixed space of the gas-liquid mixture is formed by a liquid after entering the vacuum tank; the gas-phase space is formed above the mixed space and communicates with the mixed space; and
the gas-liquid mixture is discharged out of the vacuum tank via the outlet thereof by the pump for extraction of the gas-liquid mixture; part of gas enters the gas-phase space; and water vapor in the gas-phase space is condensed into a liquid state or a solid state by the condenser, and water in the liquid state or the solid state is discontinuously or continuously discharged out of the vacuum tank via the water discharging device.

2. The device of claim 1, wherein a liquid pump is connected to a bottom of the vacuum tank.

3. The device of claim 1, wherein the gas-phase space comprises a gas circulation loop; the gas circulation loop communicates with the vacuum tank for gas circulation; and the condenser is disposed in the gas circulation loop.

4. The device of claim 2, wherein the gas-phase space comprises a gas circulation loop; the gas circulation loop communicates with the vacuum tank for gas circulation; and the condenser is disposed in the gas circulation loop.

5. The device of claim 1, wherein a blower is disposed in the gas-phase space for increasing a gas exchange rate in the vacuum tank.

6. The device of claim 4, wherein a blower is disposed in the gas-phase space for increasing a gas exchange rate in the vacuum tank.

7. The device of claim 1, wherein the condenser adopts cold water cooling, compressor refrigeration, semiconductor refrigeration, or a combination thereof;
and a heat quantity produced from refrigeration of the condenser is carried away by the low-volatile liquid.

8. The device of claim 6, wherein the condenser adopts cold water cooling, compressor refrigeration, semiconductor refrigeration, or a combination thereof; and heat quantity produced from refrigeration of the condenser is carried away by the low-volatile liquid.

9. A method for vacuum dehydration of a low-volatile liquid, the method comprising:
a) injecting a low-volatile liquid into a vacuum tank, and evaporating water vapor and gas from the liquid to form a gas-liquid mixture; partially separating the gas-liquid mixture under the action of the gravity, whereby producing a mixed space of a gas-liquid mixture and a gas-phase space communicating with the mixed space in a chamber of the vacuum tank;
b) condensing the water vapor in the gas-phase space into:
c) a liquid state, wherein the water in the liquid state is discontinuously or continuously discharged out of the vacuum tank; and/or
d) a solid state, wherein the water in the solid state is discontinuously discharged out of the vacuum tank after being melted; and
e) extracting the gas-liquid mixture from the mixed space out of the vacuum tank whereby maintaining the vacuum tank at a negative pressure state.

10. The method of claim 9, wherein a gas circulation loop is added in b) to facilitate a flow of the water vapor to the condenser.

11. The method of claim 10, wherein the gas circulation loop adopts a vacuum pipe communicating with the gas-phase space of the vacuum tank, and a gas flow is appropriately guided to facilitate the flow of the water vapor to the condenser whereby increasing the dehydration rate.

12. The method of claim 9, wherein a blower is adopted in b) for enhancing a gas flow in the gas-phase space whereby increasing the dehydration rate.

13. The method of claim 11, wherein a blower is adopted in b) for enhancing the gas flow in the gas-phase space whereby increasing the dehydration rate.

14. The method of claim 9, wherein a heat quantity produced in refrigeration of the condenser in b) is carried away by the low-volatile liquid.

15. The method of claim 12, wherein a heat quantity produced in refrigeration of the condenser in b) is carried away by the low-volatile liquid.

16. The method of claim 13, wherein a heat quantity produced in refrigeration of the condenser in b) is carried away by the low-volatile liquid.

17. The method of claim 9, wherein part of the liquid is extracted from the mixed space by a liquid pump so as to increase treatment capacity of the low-volatile liquid.

18. The method of claim 14, wherein part of the liquid is extracted from the mixed space by a liquid pump so as to increase treatment capacity of the low-volatile liquid.

19. The method of claim 15, wherein part of the liquid is extracted from the mixed space by a liquid pump so as to increase treatment capacity of the low-volatile liquid.

20. The method of claim 16, wherein part of the liquid is extracted from the mixed space by a liquid pump so as to increase treatment capacity of the low-volatile liquid.
